(19) United States
(12) Patent Application Publication
(10) Pub. No.: US 2024/0391297 A1
(43) Pub. Date: Nov. 28, 2024

(54) VENTILATION DEVICE COMPRISING AT LEAST ONE AUTOMATICALLY CLOSING FLAP, AIRCRAFT COMPRISING AT LEAST ONE SUCH VENTILATION DEVICE

(71) Applicants: Airbus Operations SAS, TOULOUSE (FR); Airbus Operations GmbH, HAMBURG (DE)

(72) Inventors: Nicolas FURIASSE PASSALACQUA, HAMBURG (DE); Christophe CASSE, TOULOUSE (FR)

(21) Appl. No.: 18/673,949

(22) Filed: May 24, 2024

(30) Foreign Application Priority Data
May 26, 2023 (FR) 2305230

(51) Int. Cl. B60H 1/26; A62C 2/06; A62C 3/08

(52) U.S. Cl. CPC B60H 1/26; A62C 3/08; A62C 3/14; B64D 25/00

(57) ABSTRACT

A ventilation device comprising a ventilation grille comprising a frame delimiting at least one opening, at least one flap designed to be in an open state in which the flap at least partially opens the opening and a closed state in which the flap blocks the opening, at least one articulation connecting the flap and the frame, a closed position holding system that is elastically deformable and designed to push and hold the flap in the closed state, an open position holding system that is fusible and designed to hold the flap in the open state against the closed position holding system, enabling the flap to be closed automatically. Also an aircraft having at least one such ventilation device.

### CROSS-REFERENCES TO RELATED APPLICATIONS

This application claims the benefit of French Patent Application Number 2305230 filed on May 26, 2023, the entire disclosure of which is incorporated herein by way of reference.

### FIELD OF THE INVENTION

The present application relates to a ventilation device including at least one self-closing flap, as well as to an aircraft comprising at least one such ventilation device.

### BACKGROUND OF THE INVENTION

According to an embodiment shown in FIGS. 1 and 2, an aircraft 10 comprises a fuselage 12 that extends between a nose cone 12.1 and a tail cone 12.2, wings 14 positioned on both sides of the fuselage 12, and a central wing box connecting the wings 14 and the fuselage 12.

For the present application, a longitudinal direction X is a direction parallel to a longitudinal axis, which is horizontal when the aircraft is on the ground, and extends between the nose cone 12.1 and the tail cone 12.2. A transverse direction is a direction that is horizontal when the aircraft is on the ground and perpendicular to the longitudinal direction. A longitudinal plane is a plane that is vertical when the aircraft is on the ground and parallel to the longitudinal axis. A transverse plane is a plane perpendicular to the longitudinal axis. The terms “front” and “rear” refer to the air flow direction around the aircraft in flight, the air flowing from the front to the rear.

The fuselage 12 comprises a belly fairing 16 located beneath the central wing box, as well as ventilation grilles 18 positioned in the belly fairing 16.

Each ventilation grille 18 comprises a frame 20 having front and rear sides 20.1, 20.2 that are parallel to each other in the transverse direction, and right- and left-hand sides 20.3, 20.4 that are parallel to each other in the longitudinal direction, as well as transverse inclined slats 22 connecting the right- and left-hand sides 20.3, 20.4 that are parallel to each other. As illustrated in FIG. 3, each slat 22 comprises a first transverse edge 22.1 oriented toward the outside of the fuselage 12 and a second transverse edge 22.2 oriented toward the inside of the fuselage 12, the second transverse edge 22.2 being offset toward the rear side 20.2 in relation to the first transverse edge 22.1.

As illustrated in FIG. 3, in the event of fire beneath the belly fairing 16, it is necessary to protect equipment 24 located in the fuselage 12 in the vicinity of the ventilation grille 18 to ensure that the flames, which could enter the fuselage 12 via the ventilation grille 18, do not impact the equipment 24.

To protect the equipment, the aircraft may comprise firewalls positioned in front of the equipment 24 to be protected. However, such firewalls significantly increase the mass of the aircraft.

### SUMMARY OF THE INVENTION

The present invention is intended to overcome some or all of the drawbacks in the prior art.

For this purpose, the invention relates to a ventilation device including a ventilation grille that separates an inner zone and an outer zone and comprises a frame as well as at least one opening delimited by the frame and designed to enable an air flow to flow between the inner and outer zones.

According to the invention, the ventilation device comprises at least one flap designed to be in an open state in which the flap at least partially opens the opening and a closed state in which the flap blocks the opening, at least one articulation connecting the flap and the frame, a closed position holding system that is elastically deformable and designed to push and hold the flap in the closed state, as well as an open position holding system that is fusible and designed to hold the flap in the open state against the closed position holding system. Additionally, the articulation and the closed position holding system are the same thing.

The combination of the elastically deformable closed position holding system and the fusible open position holding system enables the flap to be closed automatically when said open position holding system is impacted and degraded by the heat of the flames. Once the flap is in the closed state, the passage of flames into the inner zone is limited. This obviates the need to provide firewalls in addition to the flap in front of the equipment to be protected that is positioned in the vicinity of the ventilation grille.

According to another feature, the flap is positioned in the inner zone.

According to another feature, the articulation is located upstream of the opening in the upstream/downstream direction, the flap having a first edge connected to the articulation as well as a second edge remote from the first edge, said second edge being separated from the frame when the flap is in the open state and immediately beside the frame when the flap is in the closed state.

According to another feature, the articulation comprises a first flange rigidly connected to the frame, a second flange rigidly connected to the flap, and an intermediate zone connecting the first and second flanges and designed to move the second flange toward the frame by elastic deformation.

According to another feature, the flap comprises a curved extension that is pressed against the second flange of the articulation and connected to the latter.

According to another feature, the open position holding system comprises at least one fusible spacer interposed between the flap and the ventilation grille, positioned at least partially level with the opening, and designed to hold the flap away from the ventilation grille against the forces exerted by the closed position holding system.

According to another feature, each fusible spacer is a strip of material having a width of between 10 and 45 mm, preferably between 15 and 25 mm, and a thickness of between 1 and 6 mm, preferably between 2 and 4 mm.

According to another feature, each fusible spacer is made of plastic or composite having a melting temperature of between 100° C. and 400° C., preferably between 150° C. and 300° C.

According to another feature, the frame has front and rear sides that are parallel to one another, and right- and left-hand sides that are parallel to one another, the flap being connected to the front side by the articulation. Additionally, the open position holding system comprises first and second fusible spacers, the first fusible spacer connecting the flap and the right-hand side of the frame, the second fusible spacer connecting the flap and the left-hand side of the frame.

According to another feature, each fusible spacer comprises a first end connected to the flap by a first connection, as well as a second end connected to the frame by a second connection, the first and second fusible spacers being connected to the flap by a first shared connection.

According to another feature, the first connection comprises a folded lug positioned equidistantly from the right- and left-hand sides, having a first flange fastened to the flap, and a second flange to which the first ends of the first and second fusible spacers are fastened.

According to another feature, for each of the first and second spacers, the second connection comprises a folded lug positioned on the right- or left-hand side of the frame, having a first flange fastened to the right- or left-hand side of the frame and a second flange to which the second end of the first or second fusible spacer is fastened.

The invention also relates to an aircraft comprising at least one ventilation device according to one of the above features.

### BRIEF DESCRIPTION OF THE DRAWINGS

Other features and advantages will become apparent from the following description of the invention, the description being given solely by way of example and with reference to the appended drawings, in which:

FIG. 1 is a side view of the aircraft,

FIG. 2 is a bottom view of a belly fairing of an aircraft including ventilation grilles,

FIG. 3 is a schematic longitudinal cross section of a ventilation grille illustrating an embodiment of the prior art,

FIG. 4 is a perspective view from a first viewing angle of a ventilation device, illustrating one embodiment of the invention,

FIG. 5 is a perspective view from a second viewing angle of the ventilation device shown in FIG. 4,

FIG. 6 is a perspective view from a third viewing angle of the ventilation device shown in FIG. 4,

FIG. 7 is a rear view of the ventilation device shown in FIG. 4,

FIG. 8 is a schematic longitudinal cross section of a ventilation device in the open state, illustrating one embodiment of the invention, and

FIG. 9 is a schematic longitudinal cross section of the ventilation device shown in FIG. 8 in the closed position.

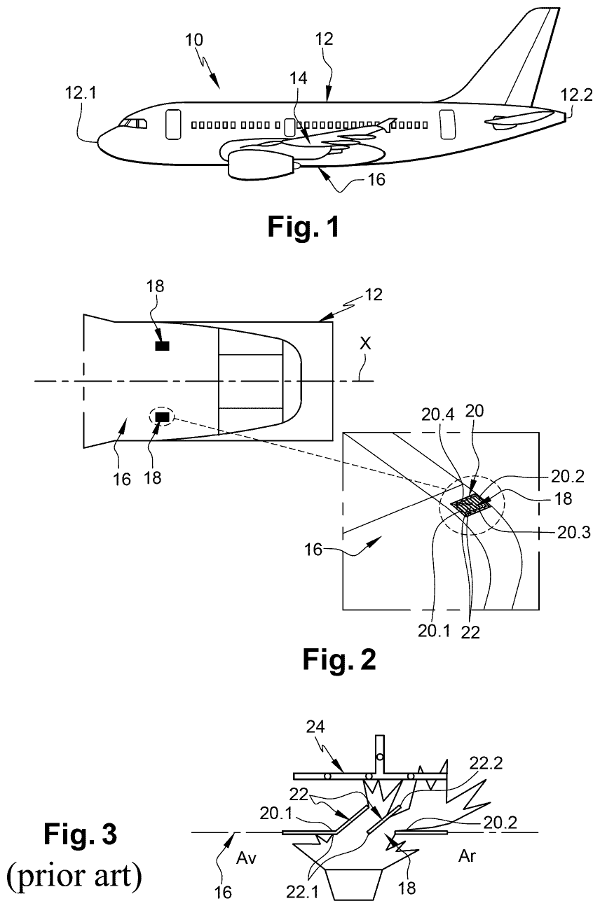

### DETAILED DESCRIPTION OF THE PREFERRED EMBODIMENTS

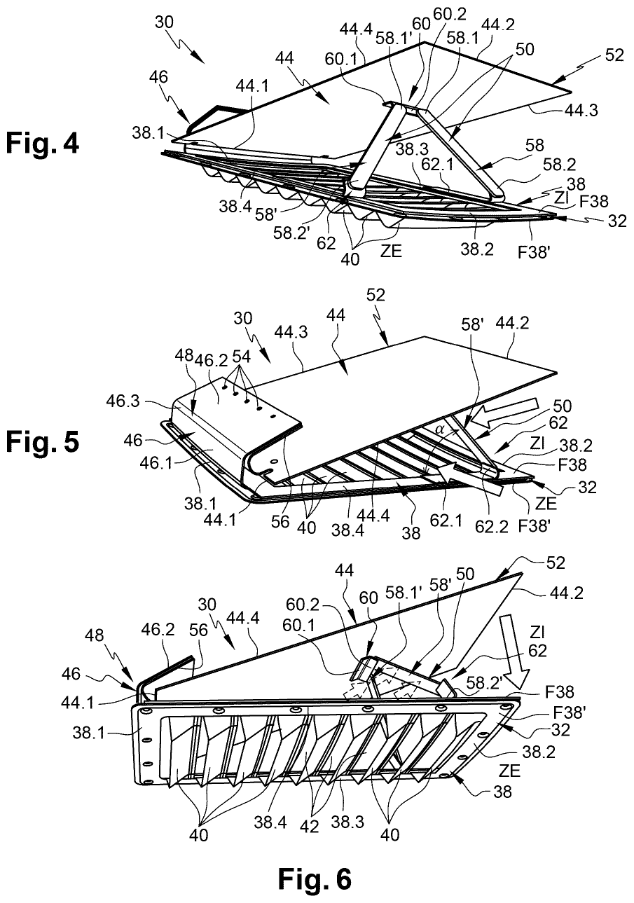

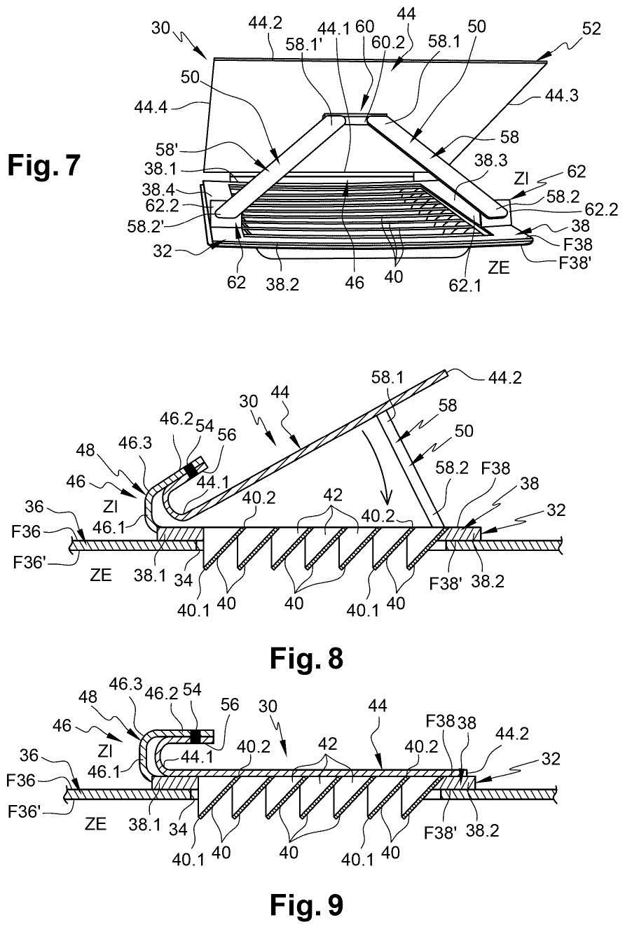

According to one embodiment shown in FIGS. 4 to 9, a ventilation device 30 comprises a ventilation grille 32 positioned in the vicinity of an orifice 34 through a wall 36 (shown in FIGS. 8 and 9). The wall 36 separates an inner zone ZI and an outer zone ZE. It has an inner surface F36 oriented toward the inner zone ZI and an outer face F36′ oriented toward the outer zone ZE.

According to one application, an aircraft comprises at least one such ventilation device 30, the wall 36 corresponding to an aerodynamic wall of the aircraft (wall in contact with an air flow circulating around the aircraft in flight), such as a belly fairing of a fuselage of an aircraft, for example.

According to one embodiment, the ventilation grille 32 comprises a frame 38 having front and rear sides 38.1, 38.2 that are parallel to each other in a first transverse direction, and right- and left-hand sides 38.3, 38.4 that are parallel to each other in a second longitudinal direction. The ventilation grille 32 comprises inclined slats 40 oriented in the first transverse direction, that connect the right- and left-hand sides 38.3, 38.4 and are parallel to each another. As illustrated in FIGS. 8 and 9, each slat 40 comprises a first transverse edge 40.1 oriented toward the outer zone ZE and a second transverse edge 40.2 oriented toward the inner zone ZI, the second transverse edge 40.2 being offset toward the rear side 38.2 in relation to the first transverse edge 40.1.

The front, rear, right-hand and left-hand sides 38.1 to 38.4 have coplanar inner faces F38 (corresponding to the inner face of the frame 38) oriented toward the inner zone ZI, as well as coplanar outer faces F38′ (corresponding to the outer face of the frame 38) oriented toward the outer zone ZE and pressed against the inner face F36 of the wall 36 when in operation, about the entirety of the orifice 34.

According to one configuration, the first transverse edges 40.1 are coplanar and offset toward the outer zone ZE in relation to the outer face F38′ of the frame 38. The second transverse edges 40.2 are coplanar and located at the inner face F38 of the frame 38.

Of course, the invention is not limited to this configuration for the ventilation grille 32. Regardless of the embodiment, the ventilation grille 32 comprises a frame 38 that delimits at least one opening 42 enabling an air flow to flow between an inner zone ZI and an outer zone ZE (from the inner zone ZI to the outer zone ZE or from the outer zone ZE to the inner zone ZI). According to one configuration, the ventilation grille 32 comprises several openings 42 between the slats 40 and between the slats 40 and the frame 38.

In the remainder of the description, a or the opening 42 shall be understood to mean one or more openings 42.

According to a specific detail of the invention, the ventilation device 30 comprises at least one movable flap 44 designed to be in an open state in which the flap 44 at least partially opens the opening 42 and a closed state in which the flap 44 blocks the opening 42, at least one articulation 46 connecting the flap 44 and the frame 38, a closed position holding system 48 that is elastically deformable and designed to move the flap 44 from the open state to the closed state and to hold it in this closed state, as well as an open position holding system 50 that is fusible and designed to hold the flap 44 in the open state against the closed position holding system 48.

The flap 44 is positioned in the inner zone ZI. It has a peripheral edge 52 designed to bear against the inner face F38 of the frame 38 about the entire perimeter thereof. According to one configuration, the peripheral edge 52 of the flap 44 is square or rectangular.

According to one embodiment, the flap 44 is made of a heat resistant material to form a firewall. The flap 44 may be made of metal, for example steel or titanium.

According to one arrangement, the flap 44 is a plate having a thickness in the order of 1.5 mm.

Thus, the combination of the elastically deformable closed position holding system 48 and the fusible open position holding system 50 enables the flap 44 to be closed automatically when the open position holding system 50 is excessively degraded by heat. When the flap 44 is in the closed state, no flames can enter the inner zone ZI. This obviates the need to provide firewalls, in addition to the flap 44, in front of the equipment to be protected that is positioned in the vicinity of the ventilation grille 32.

According to one arrangement, the articulation 46 is located upstream of the opening 42 at the front side 38.1 of the frame 38, and is designed to connect the flap 44 and the front side 38.1 of the frame 38.

The flap 44 has a first edge 44.1 connected to the articulation 46 as well as a second edge 44.2 remote from the first edge 44.1, said second edge 44.2 being separated from the rear side 38.2 of the frame 38 when the flap 44 is in the open state and immediately beside the rear side 38.2 of the frame 38 when the flap 44 is in the closed state. The flap 44 has right- and left-hand edges 44.3, 44.4 that are substantially parallel to each other, connecting the first and second edges 44.1, 44.2.

According to one embodiment, the articulation 46 and the closed position holding system 48 are the same thing and form a single element.

The articulation 46 comprises a first flange 46.1 rigidly connected to the frame 38 and more specifically to the front side 38.1, a second flange 46.2 rigidly connected to the flap 44, and an intermediate zone 46.3 connecting the first and second flanges 46.1, 46.2 that is elastically deformable. According to one configuration, the articulation 46 is a profile of constant section in a longitudinal plane (perpendicular to the inner or outer face F38, F38′ of the frame 38 and to the direction of the front side 38.1), this profile having a length that is substantially equal to or slightly less than the length of the first edge 44.1 of the flap 44.

The intermediate zone 46.3 is curved and designed to move the second flange 46.2 toward the frame 38 by elastic deformation. Thus, the intermediate zone 46.3 is deformed elastically, the second flange 46.2 forming with the inner face F38 of the frame 38 a first angle (shown in FIG. 9 and corresponding to the closed state of the flap 44) that is substantially zero when the second flange 46.2 is subjected to at least a first low or zero stress, and a second angle (shown in FIG. 8 and corresponding to the open state of the flap 44) that is greater than the first angle, of between 15° and 60°, when the second flange 46.2 is subjected to at least a second stress that is greater than the first stress, tending to move the second flange 46.2 away from the inner face F38 of the frame 38.

The first flange 46.1 is connected to the frame 38 by joining elements such as rivets for example (or by any other suitable means). The second flange 46.2 is connected to the flap 44 by joining elements 54 such as rivets for example (or by any other suitable means).

According to one configuration, the flap 44 comprises a curved extension 56 that forms a C-shape with the rest of the flap 44, pressed against the second flange 46.2 of the articulation 46 and connected to the latter by joining elements 54, such as rivets or screws for example.

Of course, the invention is not limited to this embodiment for the articulation 46 and the closed position holding system 48. Thus, these two elements may be separated. By way of example, the articulation 46 may be a hinge and the closed position holding system 48 may be a spring pushing the flap 44 to the closed state.

By way of example, the closed position holding system 48 is designed to exert a minimum force in the order of 30 N on the flap 44 to resist the pressure of the flames.

According to one embodiment, the open position holding system 50 comprises at least one fusible spacer 58 interposed between the flap 44 and the ventilation grille 32, more specifically between the flap 44 and the frame 38 of the ventilation grille 32, and designed to hold the flap 44 away from the ventilation grille 32 against the forces exerted by the closed position holding system 48. Each fusible spacer 58 is positioned at least partially level with the opening 42 to be impacted by an air flow flowing from the inner zone ZI toward the outer zone ZE or from the outer zone ZE toward the inner zone ZI, passing through the ventilation grille 32.

According to one arrangement, the open position holding system 50 comprises first and second fusible spacers 58, 58′, the first fusible spacer 58 connecting the flap 44 and the right-hand side 38.3 of the frame 38, the second fusible spacer 58′ connecting the flap 44 and the left-hand side 38.4 of the frame 38.

According to one configuration, each fusible spacer 58, 58′ is a strip of material having a length (dimension measured between the flap 44 and the ventilation grille 32) in the order of 125 mm, a width of between 10 and 45 mm, preferably between 15 and 25 mm, and a thickness of between 1 and 6 mm, preferably between 2 and 4 mm. Of course, the invention is not limited to this geometry for the fusible spacers 58, 58′.

In a longitudinal plane (perpendicular to the inner face F38 of the frame 38 and parallel to the right- and left-hand sides 38.3, 38.4), each fusible spacer 58, 58′ forms an angle in the order of 600 with the frame 38. In a transverse plane (perpendicular to the inner face F38 of the frame 38 and parallel to the front and rear sides 38.1, 38.2), each fusible spacer 58, 58′ forms an angle in the order of 45° with the frame 38.

According to one embodiment, each fusible spacer 58, 58′ is made of plastic or composite, such as a short-carbon-fiber reinforced polymer, having a melting temperature of between 100° C. and 400° C., preferably between 150° C. and 300° C. By way of example, the composite comprises a polyether ether ketone (PEEK) resin.

If any flames entered the inner zone ZI, the fusible spacers 58, 58′ are subjected to a temperature that causes them to degrade. Once the fusible spacers 58, 58′ are no longer strong enough, they cease to hold the flap 44 against the forces exerted by the closed position holding system 48, which switches to the closed state.

Each fusible spacer 58, 58′ comprises a first end 58.1, 58.1′ connected to the flap 44 by a first connection 60, as well as a second end 58.2, 58.2′ connected to the frame 38 by a second connection 62.

According to one configuration, the first and second fusible spacers 58, 58′ are connected to the flap 44 by a first shared connection 60. This first connection 60 comprises a folded lug positioned equidistantly from the right- and left-hand sides 38.3, 38.4, having a first flange 60.1 fastened (by glueing, welding or any other suitable means) to the flap 44 and a second flange 60.2 to which the first ends 58.1 of the first and second fusible spacers 58, 58′ are fastened (by glueing, welding or any other suitable means). For each of the first and second spacers 58, 58′, the second connection 62 comprises a folded lug positioned on the right- or left-hand side 38.3, 38.4 of the frame 38, having a first flange 62.1 fastened (by glueing, welding or any other suitable means) to the right- or left-hand side 38.3, 38.4 of the frame 38 and a second flange 62.2 to which the second end 58.2 of the first or second fusible spacer 58, 58′ is fastened (by glueing, welding or any other suitable means).

Of course, the invention is not limited to this embodiment for the first and second connections 60, 62 to connect the first and second fusible spacers 58, 58′ to the flap 44 or to the frame 38.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A ventilation device including a ventilation grille that separates an inner zone and an outer zone and comprises a frame as well as at least one opening delimited by the frame and designed to enable an air flow to flow between the inner and outer zones, wherein the ventilation device comprises:
at least one flap configured to be in an open state in which the at least one flap at least partially opens the at least one opening and a closed state in which the at least one flap blocks the at least one opening,
at least one articulation connecting the at least one flap and the frame,
a closed position holding system that is elastically deformable and configured to push and hold the at least one flap in the closed state, and
an open position holding system that is fusible and configured to hold the at least one flap in the open state against the closed position holding system,
wherein the articulation and the closed position holding system are the same thing.

2. The ventilation device as claimed in claim 1, wherein the at least one flap is positioned in the inner zone.

3. The ventilation device as claimed in claim 1, wherein the articulation is located upstream of the at least one opening in an upstream/downstream direction,
wherein the at least one flap has a first edge connected to the articulation as well as a second edge remote from the first edge, said second edge being separated from the frame when the at least one flap is in the open state and immediately beside the frame when the at least one flap is in the closed state.

4. The ventilation device as claimed in claim 1, wherein the articulation comprises a first flange rigidly connected to the frame, a second flange rigidly connected to the at least one flap, and an intermediate zone connecting the first and second flanges and designed to move the second flange toward the frame by elastic deformation.

5. The ventilation device as claimed in claim 4, wherein the flap comprises a curved extension that is pressed against the second flange of the articulation and connected to the articulation.

6. The ventilation device as claimed in claim 1, wherein the open position holding system comprises at least one fusible spacer interposed between the at least one flap and the ventilation grille, positioned at least partially level with the at least one opening, and configured to hold the at least one flap away from the ventilation grille against the forces exerted by the closed position holding system.

7. The ventilation device as claimed in claim 6, wherein each fusible spacer is a strip of material having a length in an order of 125 mm, a width between 10 and 45 mm, and a thickness between 1 and 6 mm.

8. The ventilation device as claimed in claim 6, wherein each fusible spacer is made of plastic or composite having a melting temperature between 100° C. and 400° C.

9. The ventilation device as claimed in claim 6, wherein the frame has front and rear sides parallel to each other, and right- and left-hand sides parallel to each other, the at least one flap being connected to the front side by the articulation, and
wherein the open position holding system comprises first and second fusible spacers, the first fusible spacer connecting the flap and the right-hand side of the frame, the second fusible spacer connecting the flap and the left-hand side of the frame.

10. The ventilation device as claimed in claim 9, wherein each fusible spacer comprises a first end connected to the at least one flap by a first connection, and a second end connected to the frame by a second connection, the first and second fusible spacers being connected to the at least one flap by a first shared connection.

11. The ventilation device as claimed in claim 9, wherein the first connection comprises a folded lug positioned equidistantly from the right- and left-hand sides, having a first flange fastened to the at least one flap and a second flange to which the first ends of the first and second fusible spacers are fastened.

12. The ventilation device as claimed in claim 10, wherein, for each of the first and second spacers, the second connection comprises a folded lug positioned on the right- or left-hand side of the frame, having a first flange fastened to the right- or left-hand side of the frame and a second flange to which the second end of the first or second fusible spacer is fastened.

13. An aircraft comprising:
the ventilation device as claimed in claim 1.
